(19) United States
(12) Patent Application Publication
(10) Pub. No.: US 2012/0080891 A1
(43) Pub. Date: Apr. 5, 2012

(54) One piece magnetic door holder

(76) Inventor: Hernando Bravo, Rockaway Beach, NY (US)

(21) Appl. No.: 12/924,665

(22) Filed: Oct. 4, 2010

(51) Int. Cl. E05C 19/16

(52) U.S. Cl. 292/251.5

(57) ABSTRACT

A magnetic doorstop including a first section consisting of a magnet secured into the door and a second section consisting of a magnet secured with a retaining shim mounted on the front side of the stop arm. The first section is attached to an interior door and the second section is attached to the frontal stop arm section. When the frontal arm section is raised, the two magnetic sections meet holding the stop arm up, once the stop arm is lowered, away from the second magnetic section, the arm will drop to the floor, stopping the door from closing.

This application emanates from a previous application filing which is related to, and claims priority through earlier filed U.S. Provisional Application No. 61/248,799, all the subject matter of which are herein incorporated by this reference thereto in their entirety for all purposes.

### FIELD OF THE INVENTION

The field of invention relates to door restraining apparatus, and more particularly pertains to a new and improved magnetic door stop apparatus wherein the same permits magnetic positioning of a door relative to an associated floor.

### BACKGROUND OF THE INVENTION

The prior art has provided various door positioning members for use in maintaining a door in a predetermined orientation relative to a wall or support surface. Examples of the prior art include U.S. Pat. No. 3,734,553 to Sugasawara wherein a spherical metallic member is mounted to a base for positioning onto a floor cooperative with a convex magnetically attractive member mounted to an associated door.

U.S. Pat. No. 3,701,557 to Centofante sets forth an adjustable door stop including a knurled sleeve threaded onto a cylinder, with an extended rubber projection mounted thereon for abutment with a door.

U.S. Pat. No. 4,669,766 to Hanchett provides for a door holding mechanism utilizing a magnetic coil mounted within a cylindrical housing and means for pivotally mounting the cylindrical housing onto an associated wall, with a door plate mounted on the door to magnetically attract the door to the cylindrical housing.

U.S. Pat. No. 4,995,655 to Freeman sets forth a magnetic door catch to position a door in an open position, wherein and adjustment as to the amount you wish to hold the door open is not an option.

U.S. Pat. No. 4,505,502 to Tomita sets forth a magnetic door catch to position a door in an open position, wherein a cup-shaped metallic member is supported for universal rotary motion in a plastic housing mounted on the door for cooperation with an associated attractive member mounted on an associated wall surface.

My invention improve the funtionality and lasting of the unit because a magnet is use to hold up the arm when is not in use. Van Dyke's products# 203774 and 0203774 use a flat metal spring that fatigue an few months resulting in a faliar of the door holder. Magnets never fatigue o wear off in consequence the unit last a must for ever

As such, it may be appreciated that there continues to be a need for a new and improved magnetic door stop wherein the same addresses both the problems of ease of use, door open adjustability as well as effectiveness in construction to provide a conveniently utilized member that may also be retrofitted to an existing door and wall structure, the present invention substantially fulfills this need.

### SUMMARY OF THE INVENTION

In view of the foregoing disadvantages inherent in the known types of magnetic door stop apparatus now present in the prior art, the present invention provides a magnetic door stop wherein the same permits ease of securement to an associated door and wall structure to enable maintaining of a door in any open position relative to a door portal. As such, the general purpose of the present invention, which will be described subsequently in greater detail, is to provide a new and improved magnetic door stop which has all the advantages of the prior art door stop apparatus and none of the disadvantages.

A arm attached to a base that pivot the arm up and down. When the arm is an a down position hold the door and when is an a up position the base as a magnet on the top for the base to hold the arm when is not in use.

My invention improve the funtionality and lasting of the unit because a magnet is use to hold up the arm when is not in use. Van Dyke's products# 203774 and 0203774 use a flat metal spring that fatigue an few months resulting in a faliar of the door holder. Magnets never fatigue o wear off in consequence the unit last a must for ever.

A knew manner of holding the arm in a door holder using a magnet on the top of the

According to various features, characteristics and embodiments of the present invention, which will become apparent as the description thereof proceeds, the present invention provides a magnetically attaching door restraining device which allows quick and simple attaching and releasing of the door stopping device without the need of springs which wear out and require continual replacement.

It is another object of this invention to provide a magnetic door holder which is easily attached to new or existing doors.

It is still another object of this invention to provide a novel door stopper which does not require continual maintanence.

### BRIEF DESCRIPTION OF THE DRAWINGS

FIG. 1 is the front perspective view of the device and all of its embodiments.

### DETAILED DESCRIPTION OF THE DRAWINGS

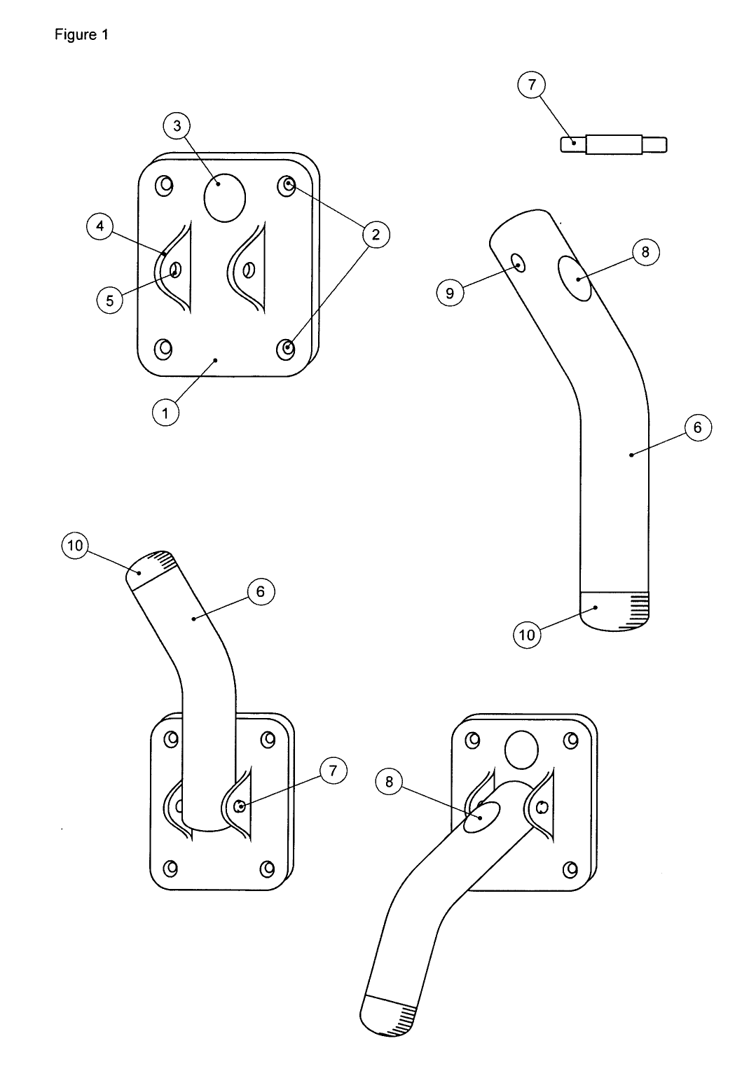

FIG. 1 (1) is the door plate which mounts to the door face, (2) is the mounting screw holes for holding the plate in place (3) is the magnet to hold up the pivotal arm when in place, (4) is the pivotal arm pin supports (5) is the pivotal arm support holes (6) is the pivotal arm which holds the door open when in use (7) is the pivotal arm pin (8) is the pivotal arm magnet to hold upright when not in use (9) is the pivotal arm pin holes (10) is the floor bumper.

What is claimed as being new and desired to be protected is as follows:

1. A one piece magnetic door holder to permit selective securement of a pivotal door relative to a horizontal floor, wherein the apparatus comprises,
an pivotal arm member securable to a door plate including a floor bumper integrally mounted to one end of the pivotal arm member extending thereof, including a permanent magnet attached within said arm, and
said door plate embodies a magnetically attractive member selectively mounted to the door plate with the pivotal arm attached to said plate by means of an attachment pin, and
a magnetically attractive plate permanently secured to the pivotal arm by which to temporarily attach to the magnetic plate on said door plate.

2. A one piece magnetic door holder of claim 1 wherein the device is embodies two attracting magnets.

3. A one piece magnetic door holder of claim 1 wherein the pivotal arm of the device embodies a magnet by which to attract the magnet on the door plate.

4. A one piece magnetic door holder to permit selective securement of a pivotal door relative to a horizontal floor, wherein the apparatus comprises,
a door plate, door plate magnet, pivotal arm, floor bumper and pivoting pin.

5. A one piece magnetic door holder of claim 1 wherein the pivotal arm stops the door from closing once released from the magnetic door plate magnet.
